(19) United States
(12) Patent Application Publication
(10) Pub. No.: US 2026/0003620 A1
(43) Pub. Date: Jan. 1, 2026

(54) PROCESSING FOR PROCESSORS PERFORMING TASKS INVOLVING LOOPS

(71) Applicant: Microsoft Technology Licensing, LLC, Redmond, WA (US)

(72) Inventors: Dushyanth BHOJARAJA, Fremont, CA (US); Prerana SATISH MASLEKAR, San Jose, CA (US)

(21) Appl. No.: 18/759,637

(22) Filed: Jun. 28, 2024

(51) Int. Cl. G06F 9/30; G06F 9/38

(52) U.S. Cl. CPC G06F 9/30065; G06F 9/325; G06F 9/3802; G06F 9/381

(57) ABSTRACT

Embodiments of the technology described herein include hardware of a processor configured to decrease the number of pipeline flushes caused by loop instructions by extracting data regarding the loop during the instruction fetch stage of the instruction cycle of the processor and/or updating the data as determined during the execution stage of the instruction cycle of the processor. In this regard, the control unit of the processor can direct the instruction fetch unit of the processor to fetch instructions of the loops based on the number of iterations of the loop as stored in a register associated with the instruction fetch stage of the processor. In this manner, certain computing devices employing embodiments of the technology described herein decrease the number of pipeline flushes, thereby increasing computational efficiency and hardware lifespan compared to using conventional technology.

### BACKGROUND

A processor, such as a central processing unit (CPU) or graphics processing unit (GPU), processes instructions and executes tasks through an instruction cycle of a pipeline involving various hardware units of the processor, such as a fetch stage, decode stage, execute stage, and a write-back stage where data from the executed instructions are written to architectural registers or memory. The pipeline is a technique used to improve processor performance by overlapping the execution of multiple instructions. For example, while a current instruction is being executed, subsequent instructions can be fetched and/or decoded and stored in a buffer to speed up processing of the subsequent instructions.

The instruction set architecture (ISA) of the processor defines the set of instructions supported by the processor hardware. In order to support tasks involving conditions, such as if-else instructions or loop instructions (for example, for-loops, while-loops, do-while-loops, and/or others), the ISA often supports branch instructions by providing a binary encoding of the branch instruction operation in machine code. Branch instructions are used to control the flow of program execution by determining whether the program counter (PC) should continue sequentially or jump to a different address (for example, the beginning of the loop body that indicates the instructions that are executed each loop iteration) based on certain conditions determined through execution of the branch instruction. As the processor must repeatedly execute the loop body and the branch instruction to determine whether the condition of a loop is met and whether the branch should be taken or not taken, the processor may need to flush the pipeline of instructions that were pre-fetched and/or decoded as the sequential flow would no longer be valid. Pipeline flushes cause stalls or delays as the pipeline must be refilled with the correct instructions from the new address, leading to computational efficiency losses. As the number of pipeline flushes and/or the size of the pipeline increases, the performance of the processor decreases due to the increase in the amount of invalid instructions fetched and/or decoded.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Various embodiments described herein decrease the number of pipeline flushes caused by loop instructions by extracting data regarding the loop during the instruction fetch stage of the instruction cycle of a processor and/or updating the data based on data determined during the execution stage of the instruction cycle of the processor. In one embodiment, a processor includes hardware configured to detect a loop from fetched encoded instructions and store the number of iterations of the loop in a register of the processor, prior to execution and/or decoding of the instructions. In this regard, the control unit of the processor can direct the instruction fetch unit of the processor to fetch instructions of the loops based on the number of iterations of the loop stored in the register before incrementing the program counter to the next instruction after the loop, thereby decreasing the number of pipeline flushes caused by prior techniques. In one embodiment, the processor includes hardware configured to determine the number of iterations of the loop during execution of the loop. The number of iterations determined during execution of the loop is used to update the number of iterations of the loop stored in the register of the processor determined during the instruction fetch stage. In this regard, in certain instances where the loop body includes exception and/or when the number of iterations can only be determined during execution of the loop, the number of iterations utilized by the control unit of the processor to direct the instruction fetch unit of the processor to fetch instructions of the loops can be resolved, thereby decreasing the number of pipeline flushes caused by prior techniques.

The present disclosure provides one or more technical solutions that have technical effects in light of various technical problems. Particular embodiments have the technical effect of improved lifespan and operation of hardware components by reducing inefficiencies in using branch instructions and/or branch predictors to process loops by processors, thereby causing an increase in pipeline flushes and/or stalls. Further, particular embodiments have the technical effect of saving power and improving computational efficiency in performing computationally expensive operations, such as those associated with using branch instructions and/or branch predictors to process loops by processors. For example, particular embodiments described herein decrease the number of pipeline flushes by extracting data regarding the loop during the instruction fetch stage of the instruction cycle, storing the data regarding the loop in a register associated with the instruction fetch stage to direct the fetch stage, and updating the data based on data determined during the execution stage of the instruction cycle. Further, particular embodiments have the technical effect of saving power, saving space on processors silicon, and improving computational efficiency in performing computationally expensive operations, such as those associated with using branch predictors to process loops by processors. For example, certain embodiments utilize simpler logical operations based on loop iterations and the program counter instead of requiring computationally expensive branch predictors.

### BRIEF DESCRIPTION OF THE DRAWINGS

The present disclosure is described in detail below with reference to the attached drawing figures, wherein:

FIG. 1 is a block diagram of an example operating environment suitable for implementations of the present disclosure;

FIG. 2 depicts a block diagram of an example computing device suitable for implementations of the present disclosure;

FIG. 3 depicts a flow diagram of a method for decreasing the number of pipeline flushes caused by loop instructions by extracting data regarding the loop during the instruction fetch stage of the instruction cycle of a processor, in accordance with an embodiment of the present disclosure;

FIG. 4 depicts a flow diagram of a method for decreasing the number of pipeline flushes caused by loop instructions by extracting data regarding the loop during the instruction fetch stage of the instruction cycle of a processor and updating the data based on data determined during the execution stage of the instruction cycle of the processor, in accordance with an embodiment of the present disclosure;

FIG. 5 is a block diagram of an example computing environment suitable for use in implementing an embodiment of the present disclosure; and

FIG. 6 is a block diagram of an example computing device suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

A processor can process instructions and execute tasks through a series of stages, each involving specific hardware units of the processor. In embodiments described herein, the processor includes a control unit (CU) that directs the operation of the processor, an execution unit (EU) that executes instructions provided by the CU, and registers are used to hold data temporarily during processing. The processor includes a PC, which is generally a register that keeps track of the address, such as a memory address or register address, of the next instruction to be executed. In this regard, the PC is initially set to the memory address of the first instruction of a software program by the control unit.

The processor includes an instruction fetch unit (IFU), which is hardware that uses the address of the PC to fetch the instruction. In some instances, such as when the address is stored in memory, the IFU copies the address stored in the PC to the memory address register (MAR), which holds the address in memory for data or instructions to be fetched or stored. The IFU then copies the instruction stored in memory based on the address in the MAR into a memory data register (MDR), which holds the data fetched from memory or to be written to memory (for example, after execution of the instructions by the processor). The IFU then copies the instruction from the MDR into an instruction register (IR), so that the instructions can be decoded by the instruction decode unit (IDU). After fetching, the PC is typically incremented by the size of the instruction to point to the next sequential instruction. For example, for a 4 byte ISA, the PC is incremented by 4 bytes to the next instruction of the program.

The fetched instruction in the IR is decoded by the IDU, where the instruction is interpreted based on the ISA to determine the required operation. The decoded instruction is updated in the IR, so that the decoded instruction can be executed by the EU. The EU, which includes the Arithmetic and Logic Unit (ALU), carries out the specified operations using the contents of the decoded instruction in the IR. The accumulator is generally a register that is used for intermediate storage of arithmetic and logic operations.

In some instances, the IR temporarily stores subsequent instructions fetched by the IFU before the instructions are decoded by the IDU. In this regard, the IFU can fetch subsequent instructions from the PC and temporarily stores the instructions in the IR to speed up processing. In some instances, the IR temporarily stores subsequent instructions decoded by the IDU before the instructions are executed by the EU. In this regard, the IDU can decode subsequent instructions from the PC and temporarily stores the decoded instructions in the IR to speed up processing.

Some prior techniques process loop instructions through the use of branch instructions. Branch instructions are used to control the flow of program execution by determining whether the PC should continue sequentially or jump to a different address (for example, the beginning of the loop body) based on certain conditions determined through execution of the branch instruction. For example, if the fetched instruction is a loop statement, the IDU identifies the type of branch instruction through the ISA and any conditions that need to be evaluated and the ALU evaluates the conditions by executing the loop body and the branch instruction, such as by comparing register values, to determine if the branch should be taken. If the branch condition is met (in the case of a conditional branch), or if the branch is unconditional, the PC is updated to the branch target address. This address can be an absolute address provided in the instruction or a relative address calculated as an offset from the current PC value. If the branch is not taken, the PC increments to the next sequential instruction address.

As the processor must repeatedly execute the body of the loop statement and the branch instruction to determine whether the condition of a loop is met and whether the branch should be taken or not taken, the processor may need to flush the pipeline of instructions that were pre-fetched and/or decoded as the sequential flow would no longer be valid. Pipeline flushes cause stalls or delays as the pipeline must be refilled with the correct instructions from the new address, leading to computational efficiency losses. As the number of pipeline flushes and/or the size of the pipeline increases, the performance of the processor decreases due to the increase in the amount of invalid instructions fetched and/or decoded. Thus, pipeline flushes caused by the processing of branch instructions for loops can increase power consumption by the processor, decrease lifespan for the processor, and decrease the performance of the processor.

Some prior techniques use branch predictors. A branch predictor is a component that attempts to predict the outcome of a branch instruction, such as whether the branch will be taken. However, branch predictors are not 100% accurate. If the prediction is incorrect, the pipeline must still be flushed, and the correct instructions must be fetched and executed, resulting in performance penalties. Further, branch predictors require a warmup period to first determine that there is a loop and an additional warmup period to begin to make predictions above a threshold accuracy. Even further, branch predictors add additional constraints to chip design as the branch predictor will necessarily take up space on the processor. Thus, pipeline flushes caused by the mispredictions of branch instructions for loops by branch predictors can increase power consumption by the processor, decrease lifespan for the processor, and decrease the performance of the processor.

A specific example of how a for-loop is mapped to assembly code using branch instructions is provided as follows:

High Level Programming Language
for (uint32_t i = 0; i < 32; i++)
{
// code for loop body
}
Assembly Code
movi i0, 32
_label:
# assembly code for loop body
addi i1, i1, 1
bne i0, i1, _label

As can be understood, the assembler then translates the assembly code into a binary encoding of the branch instruction operation in machine code based on the ISA of the processor. In this regard, during execution of the branch instructions by the processor, the branch instruction can branch back to “_label” or branch to the next instruction of the PC after the loop. As the determination whether the branch should be taken or not taken can only be made in the execute stage of the pipeline, the instruction fetch stage can either (1) stall the instruction fetch pipeline until the resolution of the branch direction, which causes multiple stall cycles for each iteration of the loop; (2) always speculate the direction of the branch to be not taken, which will cause a pipeline flush for each iteration of the loop; (3) always speculate the direction of the branch to be taken, which will always cause a pipeline flush for the final iteration of the loop; or (4) use a branch predictor, which will cause pipeline flushes for each misprediction (for example, assuming a 90% accuracy for 32 iterations of the for loop, the branch predictor will cause 3-4 mispredictions).

As shown by this example, certain existing approaches for the processing of branch instructions for loops will often result in pipeline flushes, which increases power consumption by the processor, decreases lifespan for the processor, and decreases performance for certain workloads.

To address these and other technical issues, certain embodiments disclosed herein include a loop instruction fetch circuit of a processor configured to detect a loop from fetched encoded instructions, prior to execution and/or decoding of the instructions. The loop instruction fetch circuit stores instruction bits corresponding to fetched loop data, such as the number of loop iterations of the loop and the number of fetch operations performed for the loop, in a register. In this regard, the CU can direct the IFU to fetch instructions of the loops based on the number of iterations of the loop stored in the register before incrementing the PC to the next instruction after the loop, thereby decreasing the number of pipeline flushes caused by prior techniques. Certain embodiments disclosed herein include a loop instruction execution circuit of the processor configured to store instruction bits corresponding to executed loop data, such as the number of loop iterations of the loop determined during execution of the loop instructions by the EU, in another register. In this regard, instruction bits corresponding to executed loop data can be used to update the instruction bits corresponding to the fetched loop data to provide the number of iterations of the loop to the IFU when the number of iterations can only be determined during execution of the loop, thereby decreasing the number of pipeline flushes caused by prior techniques.

In certain embodiments, a compiler translates a loop (for example, a for-loop) of high level programming language into assembly code corresponding to the loop instruction. Data of the loop instruction, such as an indication of the loop, an indication of the type of loop, an indication of the loop body, an indication of the specified number of iterations of the loop, and/or an indication that the number of iterations of the loop is not specified, is included in the assembly code corresponding to the loop instruction. The assembler then translates the assembly code into an encoded representation of the loop instruction in machine code based on the ISA of a processor and stores the encoded representation of the loop instruction in memory. The encoded representation of the loop instruction includes a corresponding encoded representation of the data of the loop instruction, such as an indication of the loop, an indication of the type of loop, an indication of the loop body, an indication of the specified number of iterations of the loop, and/or an indication that the number of iterations of the loop is not specified.

In certain embodiments, the processor includes an IFU and a loop instruction fetch circuit. Certain embodiments disclosed herein include that the loop instruction fetch circuit is hardened into the processor. In one example, “hardened” to the processor refers to the original manufacturing specification of the processor, such that the datatype format being hardened into the processor means that the processor was designed or manufactured to process requests according to the hardened datatype format. In some embodiments, the loop instruction fetch circuit is a portion of the circuit of the IFU. The loop instruction fetch circuit of the processor is configured to detect the loop instruction from fetched instructions during the fetch stage of the instruction cycle, prior to execution and/or decoding of the instructions. For example, when the IFU fetches the instruction based on the memory address the instruction stored in the PC, the loop instruction fetch circuit detects the encoded representation of the loop instruction based on the indication of the loop in the corresponding encoded representation of the data of the loop instruction.

In certain embodiments, during the fetch stage of the instruction cycle, the loop instruction fetch circuit extracts data regarding the loop instruction, such as the number of loop iterations, and stores a corresponding representation of extracted data from the fetched loop instruction in a register. For example, when the loop instruction fetch circuit detects the encoded representation of the loop instruction, the loop instruction fetch circuit extracts data from the corresponding encoded representation of the data of the loop instruction, such as an indication of the type of loop, an indication of the loop body, an indication of the specified number of iterations of the loop, and/or an indication that the number of iterations of the loop is not specified to store a corresponding representation of extracted data from the fetched loop instruction in a register, such as the IR. As an example, the corresponding representation of the extracted data from the fetched loop instruction can be stored in a loop instruction fetch register of the IR. In certain embodiments, the corresponding representation of the extracted data from the fetched loop instruction can be stored in any register utilized by the CU, IFU, and/or loop instruction fetch circuit.

In certain examples, the IFU can fetch the loop body from the PC based on the number of iterations of the loop instruction indicated in the corresponding representation of the extracted data from the fetched loop instruction. For example, each time the CU directs the IFU to fetch the loop body from the PC, the CU can update a corresponding representation of the number of fetched loop iterations stored in the register. The CU compares the value corresponding to the number of fetched loop iterations stored in the register to the number of iterations of the loop instruction indicated in the corresponding representation of the extracted data from the fetched loop instruction to determine whether to direct the IFU to fetch the loop body from the PC for another loop iteration or whether to increment the PC to the next instruction after the loop instruction. In certain examples, the CU, IFU, and/or the loop instruction fetch circuit can update the data in the register to store the number of fetched loop iterations performed by the IFU. In certain examples, the CU, IFU, and/or the loop instruction fetch circuit can compare the value corresponding to the number of fetched loop iterations stored in the register to the number of iterations of the loop instruction indicated in the corresponding representation of the extracted data from the fetched loop instruction to determine whether the IFU should fetch the loop body from the PC or whether to increment the PC to the next instruction after the loop instruction.

In certain embodiments, the processor includes an EU and a loop instruction execution circuit. Certain embodiments disclosed herein include that the loop instruction execution circuit is hardened into the processor. In some embodiments, the loop instruction fetch circuit is a portion of the circuit of the EU. The loop instruction execution circuit of the processor is configured to detect, extract, and/or store a corresponding representation of executed data from the executed loop instruction in a register based on executed instructions during the execution stage of the instruction cycle. For example, the IDU decodes instructions based on the ISA of the processor and stores the decoded instructions in the IR. When the EU executes the decoded instructions stored in the IR, such as by performing comparison operations to determine whether conditions of the loop instruction are met by the ALU, the EU can extract and/or store the corresponding representation of executed data from the executed loop instruction in the register. For example, the corresponding representation of executed data from the executed loop instruction can include executed data, such as an indication of the type of loop, an indication of the loop body, an indication of the specified number of iterations of the loop, an indication that the number of iterations of the loop is not specified, and/or an indication of a determined number of loop iterations of the loop when the number of iterations of the loop is not specified and determined based on execution of the loop by the EU.

In certain embodiments, the corresponding representation of executed data from the executed loop instruction can be used to update the corresponding representation of the extracted data from the fetched loop instruction in the register so that the CU, IFU, and/or the loop instruction fetch circuit can utilize data determined during the execution stage. In certain embodiments, the corresponding representation of executed data from the executed loop instruction can be stored in a register that is different than the register used to the corresponding representation of the extracted data from the fetched loop instruction, such as a different register or a different location of a register. In certain embodiments, the CU, EU, IFU, loop instruction fetch circuit, and/or loop instruction execution circuit can utilize data from the corresponding representation of executed data from the executed loop instruction stored in the different register to update the corresponding representation of the extracted data from the fetched loop instruction in the register, so that the CU, IFU, and/or the loop instruction fetch circuit can utilize data determined during the execution stage.

In certain examples, such as when the number of loop iterations is specified in the loop instruction of the high level programming language and/or assembly code, data of the corresponding representation of executed data from the executed loop instruction can be used to update data of the corresponding representation of the extracted data from the fetched loop instruction. For example, the data of the corresponding representation of executed data from the executed loop instruction may be used to handle any issues determined during the execution stage, such as exceptions, that were not extracted by from the fetch loop instruction by the loop instruction fetch circuit. In this regard, the number of pipeline flushes are reduced as the instruction fetch stage will typically fetch the correct number of loops. In a minimal number of cases, there may be a single pipeline flush if an exception is reached during the execution stage while the instruction fetch has fetched subsequent instructions. However, a single pipeline flush in a minimal number of scenarios is significantly less than the number of pipeline flushes encountered in branch instruction implementations.

In certain examples, such as when the number of loop iterations is not specified in the loop instruction of the high level programming language and/or assembly code and must be determined during execution of the loop instruction, data corresponding to the number of loop iterations of the loop determined in the execution stage and stored in the corresponding representation of executed data from the executed loop instruction can be used to update data of the corresponding representation of the extracted data from the fetched loop instruction. For example, when the number of loop iterations is not provided in the loop instruction, the value of the number of loop iterations in the corresponding representation of the extracted data from the fetched loop instruction can be set to a threshold value, such as a maximum value based on the size of the register (for example, a maximum 32-bit value). During execution of the each decoded instruction of the loop by the EU, the number of loop iterations is determined by the EU and stored as a corresponding value in the corresponding representation of executed data from the executed loop instruction. The value of the number of loop iterations in the corresponding representation of the extracted data from the fetched loop instruction can be updated based on the corresponding value in the corresponding representation of executed data from the executed loop instruction. In this way, the IFU can fetch the correct number of iterations of the loop instruction based on the updated value of the number of loop iterations in the corresponding representation of the extracted data from the fetched loop instruction before incrementing the PC to the next instruction following the loop instruction. In this regard, the number of pipeline flushes are reduced as the execution stage will typically determine the number of the loops before the instruction fetch stage fetches instructions beyond the number of loops. In a minimal number of cases, there may be a single pipeline flush if the number of loop iterations is very small and the instruction fetch stage fetches instructions beyond the total number of loops before the execution stage determines the total number of loops required. However, a single pipeline flush in a minimal number of scenarios is significantly less than the number of pipeline flushes encountered in branch instruction implementations.

The present disclosure provides one or more technical solutions that have technical effects in light of various technical problems. Particular embodiments have the technical effect of improved lifespan and operation of hardware components by reducing inefficiencies in using branch instructions and/or branch predictors to process loops by processors, thereby causing an increase in pipeline flushes and/or stalls. Further, particular embodiments have the technical effect of saving power and improving computational efficiency in performing computationally expensive operations, such as those associated with using branch instructions and/or branch predictors to process loops by processors. For example, particular embodiments described herein decrease the number of pipeline flushes by extracting data regarding the loop during the instruction fetch stage of the instruction cycle, storing the data regarding the loop in a register associated with the instruction fetch stage to direct the fetch stage, and updating the data based on data determined during the execution stage of the instruction cycle. Further, particular embodiments have the technical effect of saving power, saving space on processors silicon, and improving computational efficiency in performing computationally expensive operations, such as those associated with using branch predictors to process loops by processors. For example, certain embodiments utilize simpler logical operations based on loop iterations and the program counter instead of requiring computationally expensive branch predictors.

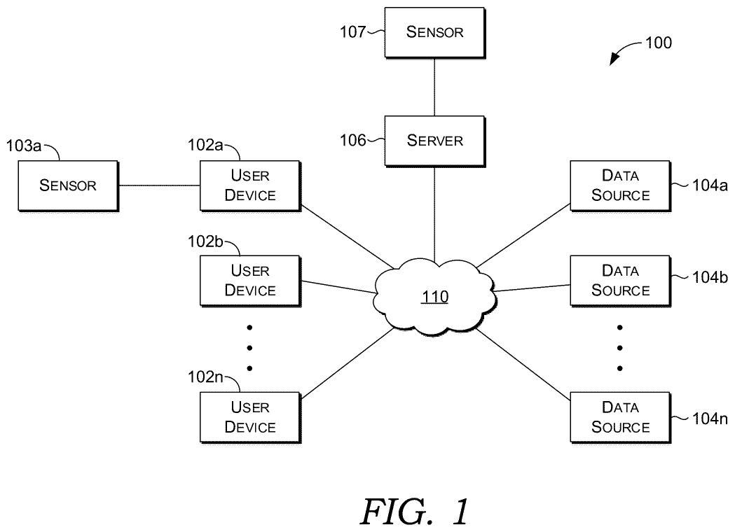

Turning now to FIG. 1A, a block diagram is provided showing an example operating environment 100 in which some embodiments of the present disclosure can be employed. It should be understood that this and other arrangements described herein are set forth only as examples. Other arrangements and elements (for example, machines, interfaces, functions, orders, and groupings of functions) can be used in addition to or instead of those shown, and some elements can be omitted altogether for the sake of clarity. Further, many of the elements described herein are functional entities that are implemented as discrete or distributed components or in conjunction with other components, and in any suitable combination and location. Various functions described herein as being performed by one or more entities are carried out by hardware, firmware, and/or software. For instance, some functions are carried out by a processor executing instructions stored in memory.

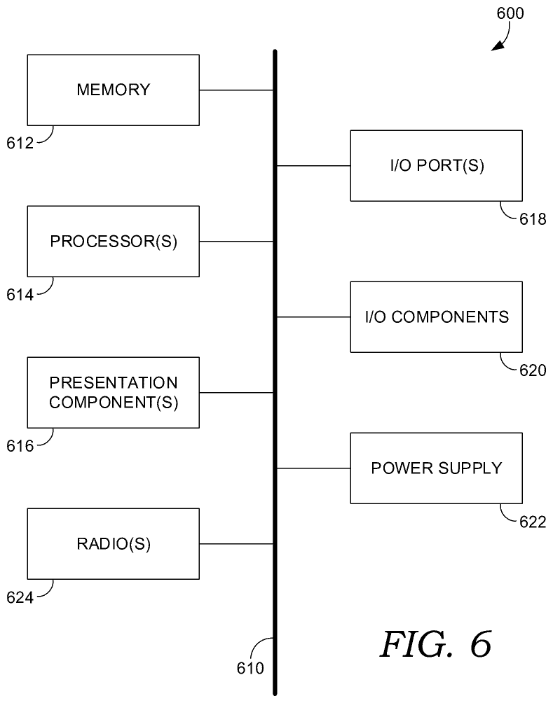

Among other components not shown, example operating environment 100 includes a number of user computing devices, such as user devices 102a and 102b through 102n; a number of data sources, such as data sources 104a and 104b through 104n; server 106; sensors 103a and 107; and network 110. It should be understood that operating environment 100 shown in FIG. 1A is an example of one suitable operating environment. Each of the components shown in FIG. 1A is implemented via any type of computing device, such as computing device 500 illustrated in FIG. 6, for example. In one embodiment, these components communicate with each other via network 110, which includes, without limitation, one or more local area networks (LANs) and/or wide area networks (WANs). In one example, network 110 comprises the internet, intranet, and/or a cellular network, amongst any of a variety of possible public and/or private networks.

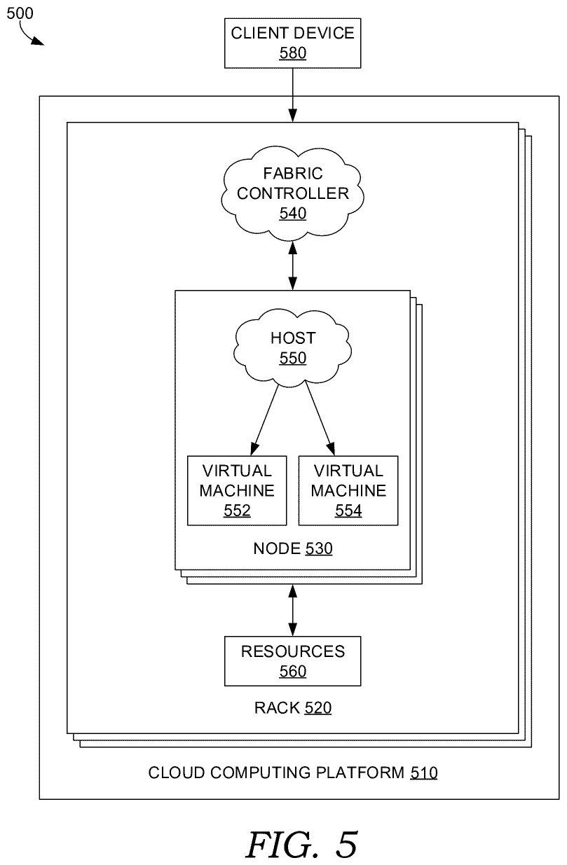

It should be understood that any number of user devices, servers, and data sources can be employed within operating environment 100 within the scope of the present disclosure. Each may comprise a single device or multiple devices cooperating in a distributed environment, such as the distributed computing environment 500 in FIG. 5. For instance, server 106 is provided via multiple devices arranged in a distributed environment that collectively provides the functionality described herein. Additionally, other components not shown may also be included within the distributed environment.

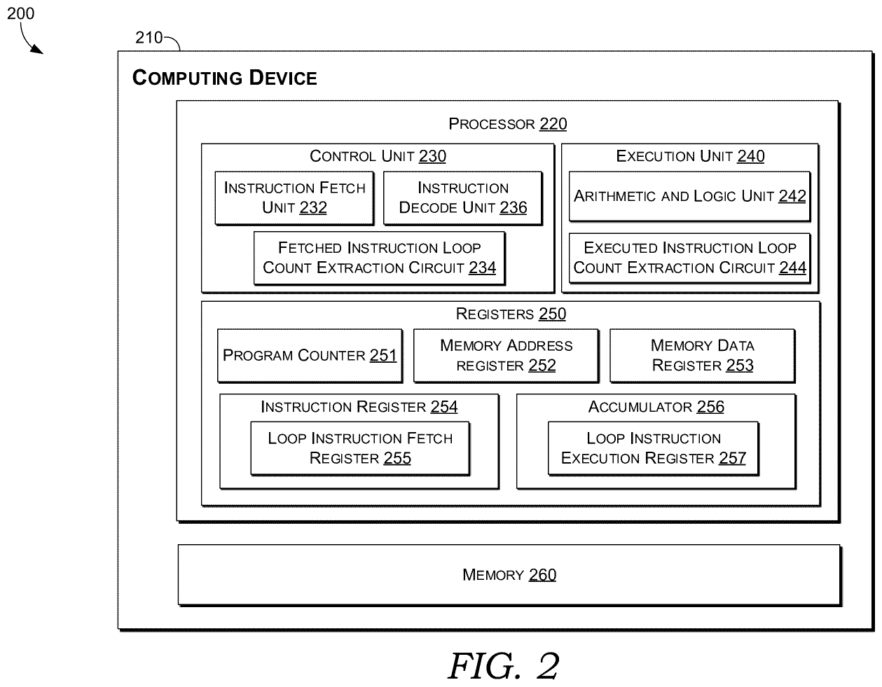

User devices 102a and 102b through 102n can be client user devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. For example, user device 102a associated with a user account can communicate workloads over network 110 to the server 106 for processing consistently with a corresponding service-level agreement (SLA). This division of operating environment 100 is provided to illustrate one example of a suitable environment, and there is no requirement for each implementation that any combination of server 106 and user devices 102a and 102b through 102n remain as separate entities. In one embodiment, the server 106 includes certain components of diagrams 200, 300, 400, 500, and 600 of FIGS. 2, 3, 4, 5, and 6, respectively.

In some embodiments, user devices 102a and 102b through 102n comprise any type of computing device capable of use by a user. For example, in one embodiment, user devices 102a and 102b through 102n are the type of computing device 600 described in relation to FIG. 6. By way of example and not limitation, a user device is embodied as a personal computer (PC), a laptop computer, a mobile device, a smartphone, a smart speaker, a tablet computer, a smart watch, a wearable computer, a personal digital assistant (PDA) device, a virtual-reality (VR) or augmented-reality (AR) device or headset, music player or an MP3 player, a global positioning system (GPS) device, a video player, a handheld communication device, a gaming device or system, an entertainment system, a vehicle computer system, an embedded system controller, a camera, a remote control, an appliance, a consumer electronic device, a workstation, any other suitable computer device, or any combination of these delineated devices.

In some embodiments, data sources 104a and 104b through 104n comprise data sources and/or data systems, which are configured to make data available to any of the various constituents of operating environment 100 or diagrams 200, 300, 400, 500, and 600 of FIGS. 2, 3, 4, 5, and 6, respectively. For instance, one or more data sources 104a and 104b through 104n provide (or make available for accessing) may provide a loop statement stored in memory that can be accessed by a processor described in diagram 200. Certain data sources 104a and 104b through 104n are discrete from user devices 102a and 102b through 102n and server 106 or are incorporated and/or integrated into at least one of those components. In one embodiment, one or more of data sources 104a and 104b through 104n comprise one or more sensors 107, which are integrated into or are associated with one or more of the user device(s) 102a and 102b through 102n or server 106.

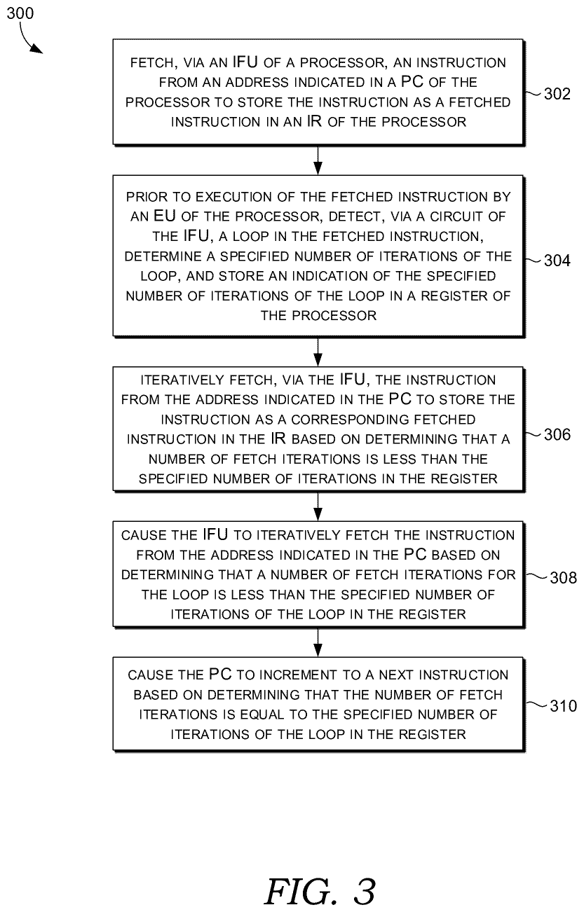

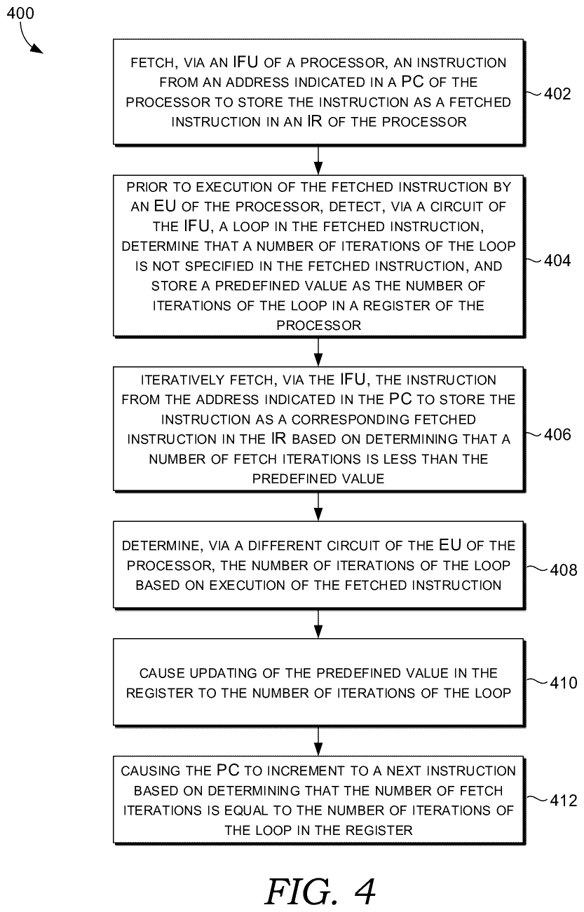

Operating environment 100 can be utilized to implement one or more of the components of diagrams 200, 500, and 600 of FIGS. 2, 5, and 6, respectively, to perform any suitable operations. Operating environment 100 can also be utilized for implementing aspects of methods 300 and 400 in FIGS. 3 and 4, respectively.

FIG. 2 illustrates an example diagram that includes an example computing device 210 suitable for use in implementing aspects of the technology described herein. As illustrated, the example computing device 210 includes a processor 220 that includes a control unit (CU) 230, an execution unit (EU) 240, and registers 250. CU 230 includes instruction fetch unit (IFU) 232, fetched instruction loop count extraction circuit 234, and instruction decode unit (IDU) 236. EU 240 includes arithmetic and logic unit (ALU) 242 and executed instruction loop count extraction circuit 244. Registers 250 include program counter (PC) 251, memory address register (MAR) 252, memory data register (MDR) 253, instruction register (IR) 254, and accumulator 256. IR 254 includes loop instruction fetch register 255 and accumulator 256 includes loop instruction execution register 257. The example computing device 210 also includes memory 260. Processor can include any suitable processor components, such as components described with respect to processor 614 of FIG. 6.

Processor 220 can process instructions and execute tasks through a series of stages of an instruction cycle, each involving specific hardware units of the processor. For example, CU 230 directs the operation of the processor, EU 240 executes instructions provided by the CU 230, and registers 250 are used to hold data temporarily during processing. Embodiments of the CU 230 of the processor 220 include circuitry that uses electrical signals to direct the entire computing device 210 to execute stored program instructions. In one example, the CU 230 does not directly execute program instructions; rather, the CU 230 directs EU 240 to execute program instructions. Embodiments of memory 260 include at least one of: primary storage (also referred to in one example as “main memory”) and secondary storage. The processor 220 interacts with primary storage referring to it for both instructions and data. In the context of primary storage, embodiments of the memory 260 hold data only temporarily while the computing device 120 executes computer-readable instructions as part of executing a program. In the context of secondary storage, embodiments of the memory 260 hold permanent or semi-permanent data on some external magnetic or optical medium, for example.

The processor 220 includes PC 251, which is generally a register that keeps track of the address, such as a memory address of memory 260 or register address of registers 250, of the next instruction to be executed. The processor 220 includes IFU 232, which is hardware that uses the address of the PC 251 to fetch the instructions. Fetching instructions by IFU 232 are referred to in examples as the fetch stage of the instruction cycle. In some instances, such as when the address is stored in memory 260, the IFU 232 copies the address stored in the PC 251 to the MAR 252, which holds the address in memory 260 for data or instructions to be fetched or stored. The IFU 232 then copies the instruction stored in memory 260 based on the address in the MAR 252 into MDR 253, which holds the data fetched from memory 260 or to be written to memory (for example, after execution of the instructions by EU 240 of processor 220). The IFU 232 then copies the instruction from the MDR 253 into IR 254, so that the instructions can be decoded by the IDU 236. After fetching, the PC 251 is typically incremented by the size of the instruction to point to the next sequential instruction. For example, for a 4 byte ISA, the PC 251 is incremented by 4 bytes to the next instruction of the program.

The fetched instruction in the IR 254 is decoded by the IDU 236, where the instruction is interpreted based on the ISA to determine the required operation. The decoded instruction is updated in the IR 254, so that the decoded instruction can be executed by the EU 240. The EU 240, which includes ALU 242, carries out the specified operations using the contents of the decoded instruction in the IR 254. The accumulator 256 is generally a register that is used for intermediate storage of arithmetic and logic operations by the ALU 256 and/or EU 240. In some embodiments, the ALU 242 of EU 240 performs any number of arithmetic operations, or mathematical calculations, such as addition, subtraction, multiplication, and division. Additionally, in some embodiments, the ALU 242 also performs logical operations, such as comparisons of any data elements such as numbers, letters, or special characters, to name a few. Other logical operations that can be performed by the ALU 242 include, among others, equal-to operations, less-than operations, greater-than operations, less-than-or-equal-to operations, greater-than-or-equal-to operations, and not-equal operations.

In some instances, the IR 254 temporarily stores subsequent instructions fetched by the IFU 232 before the instructions are decoded by the IDU 236 and executed by EU 240. In this regard, the IFU 232 can fetch subsequent instructions from the PC 251 and temporarily store the instructions in the IR 254 to speed up processing. In some instances, the IR 254 temporarily stores subsequent instructions decoded by the IDU 236 before the instructions are executed by the EU 240. In this regard, the IDU 236 can decode subsequent instructions from the PC 251 and temporarily stores the decoded instructions in the IR 254 to speed up processing.

In certain embodiments, a compiler translates a loop (for example, a for-loop) of high level programming language into assembly code corresponding to the loop instruction. Data of the loop instruction, such as an indication of the loop, an indication of the type of loop, an indication of the loop body, an indication of the specified number of iterations of the loop, and/or an indication that the number of iterations of the loop is not specified, is included in the assembly code corresponding to the loop instruction. The assembler then translates the assembly code into an encoded representation of the loop instruction in machine code based on the ISA of a processor 220 and stores the encoded representation of the loop instruction in memory 260. The encoded representation of the loop instruction includes a corresponding encoded representation of the data of the loop instruction, such as an indication of the loop, an indication of the type of loop, an indication of the loop body, an indication of the specified number of iterations of the loop, and/or an indication that the number of iterations of the loop is not specified.

In certain embodiments, the processor 220 includes an IFU 232 and a fetched instruction loop count extraction circuit 234. Certain embodiments disclosed herein include that the fetched instruction loop count extraction circuit 234 is hardened into the processor 220. In some embodiments, the fetched instruction loop count extraction circuit 234 is a portion of the circuit of the IFU 232. The fetched instruction loop count extraction circuit 234 of the processor 220 is configured to detect the loop instruction from fetched instructions during the fetch stage of the instruction cycle, prior to execution and/or decoding of the instructions. For example, when the IFU 232 fetches the instruction based on the memory address the instruction stored in the PC 251, the fetched instruction loop count extraction circuit 234 detects the encoded representation of the loop instruction based on the indication of the loop in the corresponding encoded representation of the data of the loop instruction.

In certain embodiments, during the fetch stage of the instruction cycle, the fetched instruction loop count extraction circuit 234 extracts data regarding the loop instruction, such as the number of loop iterations, and stores a corresponding representation of extracted data from the fetched loop instruction in a register, such as loop instruction fetch register 255. For example, when the fetched instruction loop count extraction circuit 234 detects the encoded representation of the loop instruction, the fetched instruction loop count extraction circuit 234 extracts data from the corresponding encoded representation of the data of the loop instruction, such as an indication of the type of loop, an indication of the loop body, an indication of the specified number of iterations of the loop, and/or an indication that the number of iterations of the loop is not specified to store a corresponding representation of extracted data from the fetched loop instruction in a register, such as the IR 254. As an example, the corresponding representation of the extracted data from the fetched loop instruction can be stored in a loop instruction fetch register 255 of the IR 254. In certain embodiments, the corresponding representation of the extracted data from the fetched loop instruction can be stored in any register of registers 250 utilized by the CU 230, IFU 232, and/or fetched instruction loop count extraction circuit 234.

In certain examples, the IFU 232 can fetch the loop body from the PC 251 based on the number of iterations of the loop instruction indicated in the corresponding representation of the extracted data from the fetched loop instruction. For example, each time the CU 230 directs the IFU 232 to fetch the loop body from the PC 251, the CU 230 can update a corresponding representation of the number of fetched loop iterations stored in the register of register 250. The CU 230 compares the value corresponding to the number of fetched loop iterations stored in the register to the number of iterations of the loop instruction indicated in the corresponding representation of the extracted data from the fetched loop instruction to determine whether to direct the IFU 232 to fetch the loop body from the PC 251 for another loop iteration or whether to increment the PC 251 to the next instruction after the loop instruction. In certain examples, the CU 230, IFU 232, and/or the fetched instruction loop count extraction circuit 234 can update the data in the register to store the number of fetched loop iterations performed by the IFU 232. In certain examples, the CU 230, IFU 232, and/or the fetched instruction loop count extraction circuit 234 can compare the value corresponding to the number of fetched loop iterations stored in the register to the number of iterations of the loop instruction indicated in the corresponding representation of the extracted data from the fetched loop instruction to determine whether the IFU 232 should fetch the loop body from the PC 251 or whether to increment the PC 251 to the next instruction after the loop instruction.

In certain embodiments, the processor 220 includes an EU 240 and an executed instruction loop count extraction circuit 244. Certain embodiments disclosed herein include that the executed instruction loop count extraction circuit 244 is hardened into the processor 220. In some embodiments, the fetched instruction loop count extraction circuit 234 is a portion of the circuit of the EU 240. The executed instruction loop count extraction circuit 244 of the processor 220 is configured to detect, extract, and/or store a corresponding representation of executed data from the executed loop instruction in a register, such as loop instruction execution register 257, based on executed instructions during the execution stage of the instruction cycle. For example, the IDU 236 decodes instructions based on the ISA of the processor 220 and stores the decoded instructions in the IR 254. When the EU 240 executes the decoded instructions stored in the IR 254, such as by performing comparison operations to determine whether conditions of the loop instruction are met by the ALU 242, the EU 240 can extract and/or store the corresponding representation of executed data from the executed loop instruction in the register of registers 250. For example, the corresponding representation of executed data from the executed loop instruction can include executed data, such as an indication of the type of loop, an indication of the loop body, an indication of the specified number of iterations of the loop, an indication that the number of iterations of the loop is not specified, and/or an indication of a determined number of loop iterations of the loop when the number of iterations of the loop is not specified and determined based on execution of the loop by the EU 240.

In certain embodiments, the corresponding representation of executed data from the executed loop instruction can be used to update the corresponding representation of the extracted data from the fetched loop instruction in the register (for example, loop instruction fetch register 255) so that the CU 230, IFU 232, and/or the fetched instruction loop count extraction circuit 234 can utilize data determined during the execution stage. In certain embodiments, the corresponding representation of executed data from the executed loop instruction can be stored in a register, such as loop instruction execution register 257, that is different than the register used to the corresponding representation of the extracted data from the fetched loop instruction, such as a different register or a different location of a register of registers 250. In certain embodiments, the CU 230, EU, IFU 232, fetched instruction loop count extraction circuit 234, and/or executed instruction loop count extraction circuit 244 can utilize data from the corresponding representation of executed data from the executed loop instruction stored in the different register to update the corresponding representation of the extracted data from the fetched loop instruction in the register, so that the CU 230, IFU 232, and/or the fetched instruction loop count extraction circuit 234 can utilize data determined during the execution stage.

In certain examples, such as when the number of loop iterations is specified in the loop instruction of the high level programming language and/or assembly code, data of the corresponding representation of executed data from the executed loop instruction (for example, as stored in loop instruction execution register 257) can be used to update data of the corresponding representation of the extracted data from the fetched loop instruction (for example, as stored in loop instruction fetch register 255). For example, the data of the corresponding representation of executed data from the executed loop instruction may be used to handle any issues determined during the execution stage, such as exceptions, that were not extracted by from the fetch loop instruction by the fetched instruction loop count extraction circuit 234. In this regard, the number of pipeline flushes are reduced as the instruction fetch stage will typically fetch the correct number of loops. In a minimal number of cases, there may be a single pipeline flush if an exception is reached during the execution stage while the instruction fetch has fetched subsequent instructions. However, a single pipeline flush in a minimal number of scenarios is significantly less than the number of pipeline flushes encountered in branch instruction implementations.

A specific example of how a for-loop is mapped to assembly code using a loop instruction defined in the ISA of processor 220 when the number of loop iterations is specified in the loop instruction of the high level programming language and/or assembly code (for example, a loop instruction with an immediate field) is provided as follows:

High Level Programming Language
for (uint32_t i = 0; i < 32; i++)
{
// code for loop body
}
Assembly Code
loopi 32, _label
# assembly code for loop body
_label:

As can be understood, the value of the loop count is encoded along with the instruction bits. In this regard, when the loop instruction is detected in the instruction fetch stage, the loop count and other information is extracted and stored in registers:

LOOP_COUNT_LOCAL = 0;
LOOP_COUNT = IMMEDIATE_VALUE;
LOOP_VALID = (LOOP_COUNT != 0);
LOOP_BEGIN = PC + 4;
LOOP_END = PC + (IMMEDIATE_VALUE * 4);
LOOP_ONCE = (LOOP_COUNT == 1);

In some embodiments, to handle any functional discrepancies due to exceptions and/or others, the instruction fetch stage holds a speculative copy of the loop information (for example in the loop instruction fetch register 255) and the execute stage holds the committed copy of the loop information (for example in the loop instruction execution register 257). In this regard, CU 230 can update the loop count based on the loop count determined in the execute stage by EU 240. In the following example, CU 230 can evaluate whether to continue in the loop as follows:

```
if((PC == LOOP_END) && LOOP_VALID)
begin
// Increment loop count
  LOOP_COUNT_LOCAL++;
  // Flush pipeline in case of bad prediction
  FLUSH_PIPELINE = LOOP_ONCE ? (nextPC != PC +
4) :
    (nextPC != LOOP_BEGIN);
  FLUSH_PIPELINE_PC = LOOP_ONCE ? PC + 4 :
LOOP_BEGIN;
  // Reset LOOP_VALID on LOOP_COUNT_LOCAL
reaching the value of LOOP_COUNT
  LOOP_VALID = (LOOP_COUNT_LOCAL <
  LOOP_COUNT);
  // Update LOOP_ONCE
  LOOP_ONCE = (LOOP_COUNT_LOCAL ==
  LOOP_COUNT − 1);
end
```

In this regard, in some embodiments, for every fetch iteration, the CU 230 can evaluate whether to fetch the loop instruction from PC 251 or increment PC 251 to the next instruction.

In certain examples, such as when the number of loop iterations is not specified in the loop instruction of the high level programming language and/or assembly code and must be determined during execution of the loop instruction, data corresponding to the number of loop iterations of the loop determined in the execution stage and stored in the corresponding representation of executed data from the executed loop instruction (for example, as stored in loop instruction execution register 257) can be used to update data of the corresponding representation of the extracted data from the fetched loop instruction (for example, as stored in loop instruction fetch register 255). For example, when the number of loop iterations is not provided in the loop instruction, the value of the number of loop iterations in the corresponding representation of the extracted data from the fetched loop instruction can be set to a threshold value, such as a maximum value based on the size of the register (for example, a maximum 32-bit value). During execution of the each decoded instruction of the loop by the EU 240, the number of loop iterations is determined by the EU 240 and stored as a corresponding value in the corresponding representation of executed data from the executed loop instruction. The value of the number of loop iterations in the corresponding representation of the extracted data from the fetched loop instruction can be updated based on the corresponding value in the corresponding representation of executed data from the executed loop instruction (for example, as stored in loop instruction execution register 257. In this way, the IFU 232 can fetch the correct number of iterations of the loop instruction based on the updated value of the number of loop iterations in the corresponding representation of the extracted data from the fetched loop instruction before incrementing the PC 251 to the next instruction following the loop instruction. In this regard, the number of pipeline flushes are reduced as the execution stage will typically determine the number of the loops before the instruction fetch stage fetches instructions beyond the number of loops. In a minimal number of cases, there may be a single pipeline flush if the number of loop iterations is very small and the instruction fetch stage fetches instructions beyond the total number of loops before the execution stage determines the total number of loops required. However, a single pipeline flush in a minimal number of scenarios is significantly less than the number of pipeline flushes encountered in branch instruction implementations.

A specific example of how a for-loop is mapped to assembly code using a loop instruction defined in the ISA of processor 220 when the number of loop iterations is not specified in the loop instruction of the high level programming language and/or assembly code and must be determined during execution of the loop instruction is provided as follows:

High Level Programming Language
for (uint32_t i = 0; i < N; i++)
{
// code for loop body
}
Assembly Code
loopi i1, _label
# assembly code for loop body
_label:

As can be understood, the value of the loop count is not known until runtime. In this regard, when the loop instruction is detected in the instruction fetch stage, the loop count can be set to 32 bit value and any other information can be extracted and stored in registers:

LOOP_COUNT_LOCAL = 0;
LOOP_COUNT = 0xFFFFFFFF; // Maximum 32b value
LOOP_VALID = (LOOP_COUNT != 0);
LOOP_BEGIN = PC + 4;
LOOP_END = PC + (IMMEDIATE_VALUE * 4);
LOOP_ONCE = (LOOP_COUNT == 1);

In some embodiments, the instruction fetch stage holds a speculative copy of the loop information (for example in the loop instruction fetch register 255) and the execute stage holds the committed copy of the loop information (for example in the loop instruction execution register 257). In some embodiments, the loop count can be determined during the execute stage by the EU 240 as follows:

LPCOUNT_COMMITTED[IMM2[1:0]] = If IMM ? IMM0[9:0]
: SR0[0][31:0]; // Take U32 value - This is the committed copy
of the LOOP instruction in the execute unit
LPCOUNT_SPECULATIVE[IMM2[1:0]] = If IMM ?
IMM0[9:0] : 0xFFFFFFFF; // Take U32 value - This is the
speculative copy of the LOOP instruction in the Instruction
Fetch unit
// LPCOUNT in the code below uses
LPCOUNT_SPECULATIVE in the Instruction Fetch unit and
LPCOUNT_COMMITTED in the Execution stage
LPCOUNT_LOCAL[IMM2[1:0]] = 32′b0;
LPVALID[IMM2[1:0]] = (LPCOUNT[IMM2[1:0]] != 0);
LPBEGIN[IMM2[1:0]] = PC + 4;
LPEND[IMM2[1:0]] = PC + (IMM1[10:0] * 4);
LPONCE[IMM2[1:0]] = (LPCOUNT[IMM2[1:0]] == 1);

In some embodiments, the speculative copy of the loop data in the fetch stage (for example as stored in loop instruction fetch register 255) and the committed copy of the loop data in the execute stage (for example as stored in loop instruction fetch register 257) can be updated as follows:

```
IMM0[9:0] : for (i = 0; i < 4; i++) // 4 copies
begin
  if((PC == LPEND[i]) && LPVALID[i])
  begin
    // Decrement loop count
    LPCOUNT_LOCAL[i]++;
    // Resteer pipeline in case of bad prediction
      RESTEER_FETCH_PC = LPONCE[i] ?
  (nextPC != PC + 4) :
        (nextPC != LPBEGIN[i]);
    RESTEER_PC = LPONCE[i] ? PC + 4 :
LPBEGIN[i];
    // Reset LPVALID on LPCOUNT = 0
    LPVALID[i] = (LPCOUNT_LOCAL[i] <
LPCOUNT[i]);
    // Update LPONCE
    LPONCE[i] = (LPCOUNT_LOCAL[i] ==
LPCOUNT[i] − 1);
  end
end
```

In this regard, in some embodiments, the loop instruction eliminates the need of branch instructions by setting up the LPVALID, LPCOUNT, LPBEGIN, LPEND and LPONCE registers and reduces the branch misprediction penalties due to the availability of the loop count. LPCOUNT (a U32 value) indicates the number of times the loop will iterate and can be programmed by the SRO register or with IMMO field. In some embodiments, the ISA can handle multiple levels of loops (for example, four levels of nested loops). In some embodiments, when the loop count is resolved in the executed stage of the pipeline (for example, by EU 240) the loop count information can be updated as follows by the CU 230 for the fetch stage:

if(LOOP_INSTRUCTION_IN_EXECUTE)
begin
// Update count based on the value in
LOOP_COUNT = In;
end

In this regard, CU 230 can update the loop count based on the loop count determined in the execute stage by EU 240. In the following example, CU 230 can evaluate whether to continue in the loop as follows:

```
if((PC == LOOP_END) && LOOP_VALID)
begin
// Increment loop count
  LOOP_COUNT_LOCAL++;
  // Flush pipeline in case of bad prediction
  FLUSH_PIPELINE = LOOP_ONCE ? (nextPC != PC +
4) :
    (nextPC != LOOP_BEGIN);
  FLUSH_PIPELINE_PC = LOOP_ONCE ? PC + 4 :
LOOP_BEGIN;
  // Reset LOOP_VALID on LOOP_COUNT_LOCAL
reaching the value of LOOP_COUNT
  LOOP_VALID = (LOOP_COUNT_LOCAL <
  LOOP_COUNT);
  // Update LOOP_ONCE
  LOOP_ONCE = (LOOP_COUNT_LOCAL ==
  LOOP_COUNT − 1);
end
```

In this regard, in some embodiments, for every fetch iteration, the CU 230 can evaluate whether to fetch the loop instruction from PC 251 or increment PC 251 to the next instruction based on the loop count information determined in the execute stage.

Turning now to FIGS. 3 and 4, aspects of example process flows 300 and 400 are illustratively depicted for some embodiments of the disclosure. Embodiments of process flows 300 and 400 each comprise a method (sometimes referred to herein as methods 300 and 400) carried out to implement various example embodiments described herein. For instance, at least one of process flow 300 and 400 is performed to programmatically to decrease the number of pipeline flushes caused by loop instructions by extracting data regarding the loop during the instruction fetch stage of the instruction cycle of a processor and/or updating the data based on data determined during the execution stage of the instruction cycle of the processor, which is used to provide any of the improved electronic technology or enhanced technical advantages, as described herein.

Each block or step of process flow 300, process flow 400, and other methods described herein comprises a computing process performed using any combination of hardware, firmware, and/or software. For instance, various functions are carried out by a processor or other hardware component executing instructions stored in memory, such as memory 612 as described in FIG. 6. Embodiments of the methods can also be embodied as computer-usable instructions stored on computer storage media. Embodiments of the methods are provided by a standalone application, a service or hosted service (standalone or in combination with another hosted service), or a plug-in to another product, to name a few. For example, the blocks of process flows 300 and 400 that correspond to actions (or steps) to be performed (as opposed to information to be processed or acted on) are carried out by one or more computer applications or services, in some embodiments, which operate on one or more user devices, and/or are distributed across multiple user devices, and/or servers, or by a distributed computing platform, and/or are implemented in the cloud, such as is described in connection with FIG. 6. In some embodiments, the functions performed by the blocks or steps of process flows 300 and 400 are carried out by components illustrated in FIGS. 1 and/or 2, for example.

With reference to FIG. 3, aspects of example process flow 300 are illustratively provided and provide a method for decreasing the number of pipeline flushes caused by loop instructions by extracting data regarding the loop during the instruction fetch stage of the instruction cycle of a processor, in accordance with an embodiment of the present disclosure. As illustrated, at block 302, example process flow 300 includes fetching, via an IFU of a processor, an instruction from an address indicated in a PC of the processor to store the instruction as a fetched instruction in an IR of the processor. At block 304, example process flow 300 includes prior to execution of the fetched instruction by an EU of the processor, detecting, via a circuit of the IFU, a loop in the fetched instruction, determining a specified number of iterations of the loop, and storing an indication of the specified number of iterations of the loop in a register of the processor.

At block 306, example process flow 300 includes iteratively fetching, via the IFU, the instruction from the address indicated in the PC to store the instruction as a corresponding fetched instruction in the IR based on determining that a number of fetch iterations is less than the specified number of iterations in the register. At block 308, example process flow 300 includes causing the IFU to iteratively fetch the instruction from the address indicated in the PC based on determining that a number of fetch iterations for the loop is less than the specified number of iterations of the loop in the register. In some embodiments, process flow 300 includes determining, via a different circuit of the EU, a number of iterations of the loop based on execution of the instruction and cause updating of the specified number of iterations of the loop in the register to the number of iterations of the loop based on execution of the instructionAt block 310, example process flow 300 includes causing the PC to increment to a next instruction based on determining that the number of fetch iterations is equal to the specified number of iterations of the loop in the register.

With reference to FIG. 4, aspects of example process flow 400 are illustratively provided and provide a method for decreasing the number of pipeline flushes caused by loop instructions by extracting data regarding the loop during the instruction fetch stage of the instruction cycle of a processor and updating the data based on data determined during the execution stage of the instruction cycle of the processor, in accordance with an embodiment of the present disclosure. As illustrated, at block 402, example process flow 400 includes fetching, via an IFU of a processor, an instruction from an address indicated in a PC of the processor to store the instruction as a fetched instruction in an IR of the processor. At block 404, example process flow 400 includes prior to execution of the fetched instruction by an EU of the processor, detecting, via a circuit of the IFU, a loop in the fetched instruction, determining that a number of iterations of the loop is not specified in the fetched instruction, and storing a predefined value as the number of iterations of the loop in a register of the processor.

At block 406, example process flow 400 includes iteratively fetching, via the IFU, the instruction from the address indicated in the PC to store the instruction as a corresponding fetched instruction in the IR based on determining that a number of fetch iterations is less than the predefined value. At block 408, example process flow 400 includes determining, via a different circuit of the EU of the processor, the number of iterations of the loop based on execution of the fetched instruction. At block 410, example process flow 400 includes causing updating of the predefined value in the register to the number of iterations of the loop. At block 412, example process flow 400 includes causing the PC to increment to a next instruction based on determining that the number of fetch iterations is equal to the number of iterations of the loop in the register.

### Other Embodiments

Various embodiments a processor, such as the processor described in any of the embodiments above, comprising a control unit (CU) and an execution unit (EU). The CU comprises an instruction fetch unit (IFU) configured to fetch an instruction from an address indicated in a program counter (PC) of the processor and store the instruction as a fetched instruction in an instruction register (IR) of the processor. The CU further comprises a circuit configured to, prior to execution of the fetched instruction by the EU, detect a loop in the fetched instruction, determine that a number of iterations of the loop is not specified in the fetched instruction and store a predefined value as the number of iterations of the loop in a register of the processor. The EU comprises a different circuit configured to determine the number of iterations of the loop based on execution of the fetched instruction and cause updating of the predefined value in the register to the number of iterations of the loop. The CU further configured to cause the PC to increment to a next instruction based on determining that the number of fetch iterations is equal to the number of iterations of the loop in the register. Advantageously, these and other embodiments, as described herein improve existing computing technologies by providing one or more technical solutions that have technical effects in light of various technical problems. Particular embodiments have the technical effect of improved lifespan and operation of hardware components by reducing inefficiencies in using branch instructions and/or branch predictors to process loops by processors, thereby causing an increase in pipeline flushes and/or stalls. Further, particular embodiments have the technical effect of saving power and improving computational efficiency in performing computationally expensive operations, such as those associated with using branch instructions and/or branch predictors to process loops by processors. For example, particular embodiments described herein decrease the number of pipeline flushes by extracting data regarding the loop during the instruction fetch stage of the instruction cycle, storing the data regarding the loop in a register associated with the instruction fetch stage to direct the fetch stage, and updating the data based on data determined during the execution stage of the instruction cycle. Further, particular embodiments have the technical effect of saving power, saving space on processors silicon, and improving computational efficiency in performing computationally expensive operations, such as those associated with using branch predictors to process loops by processors. For example, certain embodiments utilize simpler logical operations based on loop iterations and the program counter instead of requiring computationally expensive branch predictors.

In any combination of the above embodiments of the processor, the CU further configured to further cause the IFU to iteratively fetch the instruction from the address indicated in the PC and store the instruction as a corresponding subsequent fetched instruction in the IR based on determining that the number of fetch iterations is less than the number of iterations of the loop in the register.

In any combination of the above embodiments of the processor, the CU further configured to store the number of fetch iterations for the loop in a corresponding register of the processor and update the number of fetch iterations in the corresponding register each time the IFU iteratively fetches the instruction from the address indicated in the PC.

In any combination of the above embodiments of the processor, the CU further configured to cause a pipeline flush based on determining that the number of fetch iterations is greater than the number of iterations of the loop in the register.

In any combination of the above embodiments of the processor, the circuit further configured to detect the loop in the fetched instruction and determine that the number of iterations of the loop is not specified in the fetched instruction from an encoded representation of the fetched instruction in machine code before the encoded representation of the instruction is decoded by an instruction decode unit (IDU).

In any combination of the above embodiments of the processor, the predefined value corresponds to a maximum value based on a size of the register.

In any combination of the above embodiments of the processor, the EU further configured to store an indication of the number of iterations of the loop in a different register of the processor and CU updates the predefined value in the register to the number of iterations of the loop from the different register.

In any combination of the above embodiments of the processor, the instruction fetch unit comprises the circuit.

In any combination of the above embodiments of the processor, the address indicated in the program counter indicates a location in memory.

In any combination of the above embodiments of the processor, the register is a portion of the IR.

Various embodiments a processor, such as the processor described in any of the embodiments above, comprising a control unit (CU) and an execution unit (EU). The CU comprises an instruction fetch unit (IFU) configured to fetch an instruction from an address indicated in a program counter (PC) of the processor. The IFU comprises a circuit configured to, prior to execution of the instruction by the EU, detect a loop in the instruction, determine a specified number of iterations of the loop and store an indication of the specified number of iterations of the loop in a register of the processor. The CU configured to cause the IFU to iteratively fetch the instruction from the address indicated in the PC based on determining that a number of fetch iterations for the loop is less than the specified number of iterations of the loop in the register. The CU further configured to cause the PC to increment to a next instruction based on determining that the number of fetch iterations is equal to the specified number of iterations of the loop in the register. Advantageously, these and other embodiments, as described herein improve existing computing technologies by providing one or more technical solutions that have technical effects in light of various technical problems. Particular embodiments have the technical effect of improved lifespan and operation of hardware components by reducing inefficiencies in using branch instructions and/or branch predictors to process loops by processors, thereby causing an increase in pipeline flushes and/or stalls. Further, particular embodiments have the technical effect of saving power and improving computational efficiency in performing computationally expensive operations, such as those associated with using branch instructions and/or branch predictors to process loops by processors. For example, particular embodiments described herein decrease the number of pipeline flushes by extracting data regarding the loop during the instruction fetch stage of the instruction cycle, storing the data regarding the loop in a register associated with the instruction fetch stage to direct the fetch stage, and updating the data based on data determined during the execution stage of the instruction cycle. Further, particular embodiments have the technical effect of saving power, saving space on processors silicon, and improving computational efficiency in performing computationally expensive operations, such as those associated with using branch predictors to process loops by processors. For example, certain embodiments utilize simpler logical operations based on loop iterations and the program counter instead of requiring computationally expensive branch predictors.

In any combination of the above embodiments of the processor, the EU comprising a different circuit configured to determine a number of iterations of the loop based on execution of the instruction and cause updating of the specified number of iterations of the loop in the register to the number of iterations of the loop based on execution of the instruction.

In any combination of the above embodiments of the processor, the CU further configured to store the number of fetch iterations for the loop in a corresponding register and update the number of fetch iterations in the corresponding register each time the IFU iteratively fetches the instruction from the address indicated in the PC.

In any combination of the above embodiments of the processor, the CU further configured to cause a pipeline flush based on determining that the number of fetch iterations is greater than the specified number of iterations of the loop in the register.

In any combination of the above embodiments of the processor, the circuit further configured to detect the loop in the instruction and determine the specified number of iterations of the loop from an encoded representation of the instruction in machine code before the encoded representation of the instruction is decoded by an instruction decode unit (IDU).

Various embodiments are directed to computer-implemented methods comprising fetching, via an instruction fetch unit (IFU) of a processor, an instruction from an address indicated in a program counter (PC) of the processor to store the instruction as a fetched instruction in an instruction register (IR) of the processor. The computer-implemented methods include, prior to execution of the fetched instruction by an execution unit (EU) of the processor, detecting, via a circuit of the IFU of the processor, a loop in the fetched instruction, determining that a number of iterations of the loop is not specified in the fetched instruction, and storing a predefined value as the number of iterations of the loop in a register of the processor. The computer-implemented methods include, iteratively fetching, via the IFU of the processor, the instruction from the address indicated in the PC to store the instruction as a corresponding fetched instruction in the IR based on determining that a number of fetch iterations is less than the predefined value. The computer-implemented methods include, determining, via a different circuit of the EU of the processor, the number of iterations of the loop based on execution of the fetched instruction. The computer-implemented methods include, causing updating of the predefined value in the register to the number of iterations of the loop. The computer-implemented methods include, causing the PC to increment to a next instruction based on determining that the number of fetch iterations is equal to the number of iterations of the loop in the register. Advantageously, these and other embodiments, as described herein improve existing computing technologies by providing one or more technical solutions that have technical effects in light of various technical problems. Particular embodiments have the technical effect of improved lifespan and operation of hardware components by reducing inefficiencies in using branch instructions and/or branch predictors to process loops by processors, thereby causing an increase in pipeline flushes and/or stalls. Further, particular embodiments have the technical effect of saving power and improving computational efficiency in performing computationally expensive operations, such as those associated with using branch instructions and/or branch predictors to process loops by processors. For example, particular embodiments described herein decrease the number of pipeline flushes by extracting data regarding the loop during the instruction fetch stage of the instruction cycle, storing the data regarding the loop in a register associated with the instruction fetch stage to direct the fetch stage, and updating the data based on data determined during the execution stage of the instruction cycle. Further, particular embodiments have the technical effect of saving power, saving space on processors silicon, and improving computational efficiency in performing computationally expensive operations, such as those associated with using branch predictors to process loops by processors. For example, certain embodiments utilize simpler logical operations based on loop iterations and the program counter instead of requiring computationally expensive branch predictors.

In any combination of the above embodiments of the computer-implemented methods, further iteratively fetching, via the IFU of the processor, the instruction from the address indicated in the PC to store the instruction as a corresponding subsequent fetched instruction in the IR based on determining that the number of fetch iterations is less than the number of iterations of the loop in the register.

In any combination of the above embodiments of the computer-implemented methods, causing storing of the number of fetch operations for the loop in a corresponding register and causing updating of the number of fetch operations in the corresponding register each time the IFU iteratively fetches the instruction from the address indicated in the PC.

In any combination of the above embodiments of the computer-implemented methods, causing a pipeline flush based on determining that the number of fetch iterations is greater than the number of iterations of the loop in the register.

In any combination of the above embodiments of the computer-implemented methods, detecting the loop in the fetched instruction and determining that the number of iterations of the loop is not specified in the fetched instruction further comprises detecting the loop in the fetched instruction and determining that the number of iterations of the loop is not specified in the fetched instruction from an encoded representation of the fetched instruction in machine code before the encoded representation of the instruction is decoded by an instruction decode unit (IDU).

### Example Computing Environments

Having described various implementations, several example computing environments suitable for implementing embodiments of the disclosure are now described, including an example computing device and an example distributed computing environment in FIGS. 9 and 10, respectively. With reference to FIG. 6, an example computing device is provided and referred to generally as computing device 600. The computing device 600 is but one example of a suitable computing environment and is not intended to suggest any limitation as to the scope of use or functionality of embodiments of the disclosure, and nor should the computing device 600 be interpreted as having any dependency or requirement relating to any one or combination of components illustrated.

Embodiments of the disclosure are described in the general context of computer code or machine-useable instructions, including computer-useable or computer-executable instructions, such as program modules, being executed by a computer or other machine such as a smartphone, a tablet personal computer (PC), or other mobile device, server, or client device. Generally, program modules, including routines, programs, objects, components, data structures, and the like, refer to code that performs particular tasks or implements particular abstract datatypes. Embodiments of the disclosure are practiced in a variety of system configurations, including mobile devices, consumer electronics, general-purpose computers, more specialty computing devices, or the like. Embodiments of the disclosure are also practiced in distributed computing environments where tasks are performed by remote-processing devices that are linked through a communications network. In a distributed computing environment, program modules may be located in both local and remote computer storage media, including memory storage devices.

Some embodiments comprise an end-to-end software-based system that operates within system components described herein to operate computer hardware to provide system functionality. At a low level, hardware processors generally execute instructions selected from a machine language (also referred to as machine code or native) instruction set for a given processor. The processor recognizes the native instructions and performs corresponding low-level functions related to, for example, logic, control, and memory operations. Low-level software written in machine code can provide more complex functionality to higher level software. Accordingly, in some embodiments, computer-executable instructions include any software, including low-level software written in machine code, higher level software such as application software, and any combination thereof. In this regard, the system components can manage resources and provide services for system functionality. Any other variations and combinations thereof are contemplated within the embodiments of the present disclosure.

Referring now to FIG. 5, an example distributed computing environment 500 is illustratively provided, in which implementations of the present disclosure can be employed. In particular, FIG. 5 shows a high-level architecture of an example cloud computing platform 510 that can host a technical solution environment or a portion thereof (for example, a data trustee environment). It should be understood that this and other arrangements described herein are set forth only as examples. For example, as described above, many of the elements described herein are implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing environment 500 that includes cloud computing platform 510, rack 520, and node 530 (for example, computing devices, processing units, or blades) in rack 520. The technical solution environment can be implemented with cloud computing platform 510, which runs cloud services across different data centers and geographic regions. Cloud computing platform 510 can implement the fabric controller 540 component for provisioning and managing resource allocation, deployment, upgrade, and management of cloud services. Typically, cloud computing platform 510 acts to store data or run service applications in a distributed manner. Cloud computing platform 510 in a data center can be configured to host and support operation of endpoints of a particular service application. In one example, the cloud computing platform 510 is a public cloud, a private cloud, or a dedicated cloud.

Node 530 can be provisioned with host 550 (for example, operating system or runtime environment) running a defined software stack on node 530. In one example, a “node” refers to a physical computer system with a distinct host internet protocol (IP) address that is running one or more application servers. Node 530 can also be configured to perform specialized functionality (for example, computer nodes or storage nodes) within cloud computing platform 510. Node 530 is allocated to run one or more portions of a service application of a tenant. A tenant can refer to a customer utilizing resources of cloud computing platform 510. Service application components of cloud computing platform 510 that support a particular tenant can be referred to as a multitenant infrastructure or tenancy. The terms “service application,” “application,” or “service” are used interchangeably with regards to FIG. 5, and broadly refer to any software, or portions of software, that run on top of, or access storage and computing device locations within, a datacenter.

When more than one separate service application is being supported by nodes 530, certain nodes 530 are partitioned into virtual machines (for example, virtual machine 552 and virtual machine 554). Physical machines can also concurrently run separate service applications. The virtual machines or physical machines can be configured as individualized computing environments that are supported by resources 560 (for example, hardware resources and software resources) in cloud computing platform 510. It is contemplated that resources can be configured for specific service applications. Further, each service application may be divided into functional portions such that each functional portion is able to run on a separate virtual machine. In cloud computing platform 510, multiple servers may be used to run service applications and perform data storage operations in a cluster. In one embodiment, the servers perform data operations independently but exposed as a single device, referred to as a cluster. Each server in the cluster can be implemented as a node.

In some embodiments, client device 580 is linked to a service application in cloud computing platform 510. Client device 580 may be any type of computing device, and the client device 580 can be configured to issue commands to cloud computing platform 510. In embodiments, client device 580 communicates with service applications through a virtual Internet Protocol (IP) and load balancer or other means that direct communication requests to designated endpoints in cloud computing platform 510. Certain components of cloud computing platform 510 communicate with each other over a network (not shown), which includes, without limitation, one or more local area networks (LANs) and/or wide area networks (WANs).

With reference to FIG. 6, computing device 600 includes a bus 610 that directly or indirectly couples the following devices: memory 612, one or more processors 614, one or more presentation components 616, one or more input/output (I/O) ports 618, one or more I/O components 620, and an illustrative power supply 622. In one example, bus 610 represents one or more buses (such as an address bus, data bus, or combination thereof). Although the various blocks of FIG. 6 are shown with lines for the sake of clarity, in reality, these blocks represent logical, not necessarily actual, components. For example, a presentation component includes a display device, such as an I/O component. Also, processors have memory. The inventors hereof recognize that such is the nature of the art and reiterate that the diagram of FIG. 6 is merely illustrative of an example computing device that can be used in connection with one or more embodiments of the present disclosure. Distinction is not made between such categories as “workstation,” “server,” “laptop,” or “handheld device,” as all are contemplated within the scope of FIG. 6 and with reference to “computing device.”

Computing device 600 typically includes a variety of computer-readable media. Computer-readable media can be any available media that can be accessed by computing device 600 and includes both volatile and non-volatile, removable and non-removable media. By way of example, and not limitation, computer-readable media comprises computer storage media and communication media. Computer storage media includes both volatile and non-volatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 612 includes computer storage media in the form of volatile and/or non-volatile memory. In one example, the memory is removable, non-removable, or a combination thereof. Hardware devices include, for example, solid-state memory, hard drives, and optical-disc drives. Computing device 600 includes one or more processors 614 that read data from various entities such as memory 612 or I/O components 620. As used herein and in one example, the term “processor,” “processing unit,” or “a processer” refers to more than one computer processor. For example, the term processor (or “a processor”) refers to at least one processor, which may be a physical or virtual processor, such as a computer processor on a virtual machine. The term processor (or “a processor”) also may refer to a plurality of processors, each of which may be physical or virtual, such as a multiprocessor system, distributed processing or distributed computing architecture, a cloud computing system, or parallel processing by more than a single processor. Further, various operations described herein as being executed or performed by a processor are performed by more than one processor.

Presentation component(s) 616 presents data indications to a user or other device. Presentation components include, for example, a display device, speaker, printing component, vibrating component, and the like.

The I/O ports 618 allow computing device 600 to be logically coupled to other devices, including I/O components 620, some of which are built-in. Illustrative components include a microphone, joystick, game pad, satellite dish, scanner, printer, or a wireless device. The I/O components 620 can provide a natural user interface (NUI) that processes air gestures, voice, or other physiological inputs generated by a user. In some instances, inputs are transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. In one example, the computing device 600 is equipped with depth cameras, such as stereoscopic camera systems, infrared camera systems, red-green-blue (RGB) camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

Some embodiments of computing device 600 include one or more radio(s) 624 (or similar wireless communication components). The radio transmits and receives radio or wireless communications. Example computing device 600 is a wireless terminal adapted to receive communications and media over various wireless networks. Computing device 600 may communicate via wireless protocols, such as code-division multiple access (“CDMA”), Global System for Mobile (“GSM”) communication, or time-division multiple access (“TDMA”), as well as others, to communicate with other devices. In one embodiment, the radio communication is a short-range connection, a long-range connection, or a combination of both a short-range and a long-range wireless telecommunications connection. When referring to “short” and “long” types of connections, certain embodiments do not refer to the spatial relation between two devices. Instead, certain embodiments generally refer to short range and long range as different categories, or types, of connections (for example, a primary connection and a secondary connection). A short-range connection includes, by way of example and not limitation, a Wi-Fi® connection to a device (for example, mobile hotspot) that provides access to a wireless communications network, such as a wireless local area network (WLAN) connection using the 802.11 protocol; a Bluetooth connection to another computing device is a second example of a short-range connection, or a near-field communication connection. A long-range connection may include a connection using, by way of example and not limitation, one or more of code-division multiple access (CDMA), General Packet Radio Service (GPRS), Global System for Mobile Communication (GSM), time-division multiple access (TDMA), and 802.16 protocols.

Example computing devices 600 comprise any type of computing device capable of use by a user, such as a personal computer (PC), a laptop computer, a mobile device, a smartphone, a smart speaker, a tablet computer, a smart watch, a wearable computer, a personal digital assistant (PDA) device, a virtual-reality (VR) or augmented-reality (AR) device or headset, music player or an Music Player 3 (MP3) player, a global positioning system (GPS) device, a video player, a handheld communication device, a gaming device or system, an entertainment system, a vehicle computer system, an embedded system controller, a camera, a remote control, an appliance, a consumer electronic device, a workstation, any other suitable computer device, or any combination of these delineated devices.

### Additional Structural and Functional Features of Embodiments of Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

For purposes of this disclosure, the word “including” has the same broad meaning as the word “comprising,” and the word “accessing” comprises “receiving,” “referencing,” or “retrieving.” Furthermore, the word “communicating” has the same broad meaning as the word “receiving” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both; (a or b thus includes either a or b, as well as a and b).

As used herein, the term “set” may be employed to refer to an ordered (i.e., sequential) or an unordered (i.e., non-sequential) collection of objects (or elements), such as machines (for example, computer devices), physical and/or logical addresses, graph nodes, graph edges, functionalities, and the like. As used herein, a set may include N elements, where Nis any positive integer. That is, a set may include 1, 2, 3, . . . . N objects and/or elements, where N is a positive integer with no upper bound. Therefore, as used herein, a set does not include a null set (i.e., an empty set), that includes no elements (for example, N=0 for the null set). A set may include only a single element. In other embodiments, a set may include a number of elements that is significantly greater than one, two, three, or billions of elements. A set may be an infinite set or a finite set. The objects included in some sets may be discrete objects (for example, the set of natural numbers N). The objects included in other sets may be continuous objects (for example, the set of real numbers R). In some embodiments, “a set of objects” that is not a null set of the objects may be interchangeably referred to as either “one or more objects” or “at least one object,” where the term “object” may stand for any object or element that may be included in a set. Accordingly, the phrases “one or more objects” and “at least one object” may be employed interchangeably to refer to a set of objects that is not the null or empty set of objects. A set of objects that includes at least two of the objects may be referred to as “a plurality of objects.”

As used herein and in one example, the term “subset,” is a set that is included in another set. A subset may be, but is not required to be, a proper or strict subset of the other set that the subset is included within. That is, if set B is a subset of set A, then in some embodiments, set B is a proper or strict subset of set A. In other embodiments, set B is a subset of set A, but not a proper or a strict subset of set A. For example, set A and set B may be equal sets, and set B may be referred to as a subset of set A. In such embodiments, set A may also be referred to as a subset of set B. Two sets may be disjointed sets if the intersection between the two sets is the null set.

In one example, a “workload” (also referred to herein in one example as “tasks,” “jobs,” or “workflow”) refers to a series or collection of activities or computations associated with completing a task. In one example, a “workload” is also referred to as a “job,” a “task,” a “set of jobs,” or a “set of tasks.” An example AI-based workload includes aspects of raw data processing, featurization, training, inference, and deployment. In some embodiments, the workload from user accounts is classified based on the job type and the deployment type. In one example, the job type refers to the task classification and includes any suitable classification such as “basic,” “standard,” and/or “premium,” as defined by a service-level agreement (SLA).

In one example, an “accelerator,” “processor,” or “coprocessor” can be used interchangeably to refer to a piece of hardware utilized in a data center and used to run a virtual machine and/or execute a workload that includes certain tasks, such as AI-based tasks, for example, associated with an LLM. In one example, the term “coprocessor” or “accelerator” excludes central processing units (CPUs) and includes components that work in conjunction with the CPUs, such as a graphics processing unit (GPU), a field-programmable gate array (FPGA), an application-specific integrated circuit (ASIC), a Single Input, Multiple Data (SIMD) processor, or a tensor processing unit (“TPU”), among other suitable processing hardware devices.

As used herein, the terms “application” or “app” may be employed interchangeably to refer to any software-based program, package, or product that is executable via one or more (physical or virtual) computing machines or devices. An application may be any set of software products that, when executed, provide an end user one or more computational and/or data services. In some embodiments, an application may refer to a set of applications that may be executed together to provide the one or more computational and/or data services. The applications included in a set of applications may be executed serially, in parallel, or any combination thereof. The execution of multiple applications (comprising a single application) may be interleaved. For example, an application may include a first application and a second application. An execution of the application may include the serial execution of the first and second application or a parallel execution of the first and second applications. In other embodiments, the execution of the first and second application may be interleaved.

For purposes of a detailed discussion above, embodiments of the present disclosure are described with reference to a computing device or a distributed computing environment; however, the computing device and distributed computing environment depicted herein are non-limiting examples. Moreover, the terms computer system and computing system may be used interchangeably herein, such that a computer system is not limited to a single computing device, nor does a computing system require a plurality of computing devices. Rather, various aspects of the embodiments of this disclosure may be carried out on a single computing device or a plurality of computing devices, as described herein. Additionally, components can be configured for performing novel aspects of embodiments, where the term “configured for” can refer to “programmed to” perform particular tasks or implement particular abstract datatypes using code. Further, while embodiments of the present disclosure may generally refer to the technical solution environment and the schematics described herein, it is understood that the techniques described may be extended to other implementation contexts.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

1. A processor comprising a control unit (CU) and an execution unit (EU):
the CU comprising:
an instruction fetch unit (IFU) configured to fetch an instruction from an address indicated in a program counter (PC) of the processor and store the instruction as a fetched instruction in an instruction register (IR) of the processor; and
a circuit configured to, prior to execution of the fetched instruction by the EU, interpret an encoded representation of the fetched instruction in machine code to detect a first portion of the encoded representation indicating a loop in the fetched instruction and a second portion of the encoded representation indicating that a number of iterations of the loop is not specified in the fetched instruction, the circuit further configured to store a predefined value as the number of iterations of the loop in a register of the processor based on detecting the second portion, the predefined value corresponding to a maximum value based on a size of the register;
the CU configured to cause the IFU to iteratively fetch the instruction from the address indicated in the PC and store the instruction as a corresponding fetched instruction in the IR based on determining that a number of fetch iterations is less than the predefined value;
the EU comprising a different circuit configured to determine the number of iterations of the loop based on execution of the fetched instruction and cause updating of the predefined value in the register to the number of iterations of the loop; and
the CU further configured to cause the PC to increment to a next instruction based on determining that the number of fetch iterations is equal to the number of iterations of the loop in the register.

2. The processor of claim 1, the CU further configured to further cause the IFU to iteratively fetch the instruction from the address indicated in the PC and store the instruction as a corresponding subsequent fetched instruction in the IR based on determining that the number of fetch iterations is less than the number of iterations of the loop in the register.

3. The processor of claim 1, the CU further configured to store the number of fetch iterations for the loop in a corresponding register of the processor and update the number of fetch iterations in the corresponding register each time the IFU iteratively fetches the instruction from the address indicated in the PC.

4. The processor of claim 1, the CU further configured to cause a pipeline flush based on determining that the number of fetch iterations is greater than the number of iterations of the loop in the register.

5. The processor of claim 1, the circuit further configured to detect the first portion and the second portion before the encoded representation of the instruction is decoded by an instruction decode unit (IDU).

6. (canceled)

7. The processor of claim 1, the EU further configured to store an indication of the number of iterations of the loop in a different register of the processor and causes the CU to update the predefined value in the register to the number of iterations of the loop from the different register.

8. The processor of claim 1, wherein the instruction fetch unit comprises the circuit.

9. The processor of claim 1, wherein the address indicated in the program counter indicates a location in memory.

10. The processor of claim 1, wherein the register is a portion of the IR.

11. A processor comprising a control unit (CU) and an execution unit (EU):
the CU comprising:
an instruction fetch unit (IFU) configured to fetch an instruction from an address indicated in a program counter (PC) of the processor; and
the IFU comprising a circuit configured to, prior to execution of the instruction by the EU, interpret an encoded representation of the instruction in machine code to detect a first portion of the encoded representation indicating a loop in the instruction and extract a second portion of the encoded representation indicating a specified number of iterations of the loop, the circuit further configured to store an indication of the specified number of iterations of the loop in a register of the processor based on extracting the second portion; and
the CU configured to:
cause the IFU to iteratively fetch the instruction from the address indicated in the PC based on determining that a number of fetch iterations for the loop is less than the specified number of iterations of the loop in the register; and
cause the PC to increment to a next instruction based on determining that the number of fetch iterations is equal to the specified number of iterations of the loop in the register.

12. The processor of claim 11, the EU comprising a different circuit configured to determine a number of iterations of the loop based on execution of the instruction and cause updating of the specified number of iterations of the loop in the register to the number of iterations of the loop based on execution of the instruction.

13. The processor of claim 11, the CU further configured to store the number of fetch iterations for the loop in a corresponding register and update the number of fetch iterations in the corresponding register each time the IFU iteratively fetches the instruction from the address indicated in the PC.

14. The processor of claim 11, the CU further configured to cause a pipeline flush based on determining that the number of fetch iterations is greater than the specified number of iterations of the loop in the register.

15. The processor of claim 11, the circuit further configured to detect the first portion and the second portion before the encoded representation of the instruction is decoded by an instruction decode unit (IDU).

16. A computer-implemented method, comprising:
fetching, via an instruction fetch unit (IFU) of a processor, an instruction from an address indicated in a program counter (PC) of the processor to store the instruction as a fetched instruction in an instruction register (IR) of the processor;
prior to execution of the fetched instruction by an execution unit (EU) of the processor, interpreting, via a circuit of the IFU of the processor, an encoded representation of the fetched instruction in machine code to detect a first portion of the encoded representation indicating a loop in the fetched instruction and a second portion of the encoded representation indicating that a number of iterations of the loop is not specified in the fetched instruction, and storing a predefined value as the number of iterations of the loop in a register of the processor based on detecting the second portion, the predefined value corresponding to a maximum value based on a size of the register;
iteratively fetching, via the IFU of the processor, the instruction from the address indicated in the PC to store the instruction as a corresponding fetched instruction in the IR based on determining that a number of fetch iterations is less than the predefined value;
determining, via a different circuit of the EU of the processor, the number of iterations of the loop based on execution of the fetched instruction;
causing updating of the predefined value in the register to the number of iterations of the loop; and
causing the PC to increment to a next instruction based on determining that the number of fetch iterations is equal to the number of iterations of the loop in the register.

17. The computer-implemented method of claim 16, further comprising:
further iteratively fetching, via the IFU of the processor, the instruction from the address indicated in the PC to store the instruction as a corresponding subsequent fetched instruction in the IR based on determining that the number of fetch iterations is less than the number of iterations of the loop in the register.

18. The computer-implemented method of claim 16, further comprising:
causing storing of the number of fetch iterations for the loop in a corresponding register and causing updating of the number of fetch iterations in the corresponding register each time the IFU iteratively fetches the instruction from the address indicated in the PC.

19. The computer-implemented method of claim 16, further comprising:
causing a pipeline flush based on determining that the number of fetch iterations is greater than the number of iterations of the loop in the register.

20. The computer-implemented method of claim 16, further comprising:
interpreting the encoded representation to detect the first portion and the second portion before the encoded representation of the instruction is decoded by an instruction decode unit (IDU).
